(19) United States
(12) Patent Application Publication
(10) Pub. No.: US 2026/0268115 A1
(43) Pub. Date: Sep. 10, 2026

(54) SYSTEM AND METHOD FOR FEDERATED KNOWLEDGE RETRIEVAL AND LARGE LANGUAGE MODEL ENHANCEMENT

(71) Applicant: HUAZHONG UNIVERSITY OF SCIENCE AND TECHNOLOGY, Wuhan (CN)

(72) Inventors: Yu ZHANG, Wuhan (CN); Yuhe GAO, Wuhan (CN); Jin ZHAO, Wuhan (CN); Xiaofei LIAO, Wuhan (CN); Hai JIN, Wuhan (CN)

(21) Appl. No.: 19/329,957

(22) Filed: Sep. 16, 2025

(30) Foreign Application Priority Data
Mar. 6, 2025 (CN) 202510263857.0

(51) Int. Cl. G06N 3/042; H04L 9/40

(52) U.S. Cl. CPC G06N 3/042; H04L 63/0428

(57) ABSTRACT

A system and method for federated knowledge retrieval and large language model enhancement, the system including a server and hardware accelerators. The server preprocesses an input query to extract a central term and uses its caching module to retrieve the central term. Upon a cache miss, the server sends a retrieval instruction to the hardware accelerators to search their own local cache. If the local cache misses, the hardware accelerators partition a local knowledge graph to generate parallel subtasks associated with the central term for deep search, inject noise into retrieved knowledge items to protect sensitive information, and integrate them for inference by a large language model to generate an augmented response. The present disclosure establishes a two-level dynamic caching system, effectively reducing cross-device communication, prioritizing local high-frequency cache responses, and lowering overall network load.

### BACKGROUND OF THE APPLICATION

### 1. Technical Field

The present disclosure generally relates to intelligent inference and information retrieval, and more particularly to a system and method for federated knowledge retrieval and large language model (LLM) enhancement.

### 2. Description of Related Art

Knowledge graphs, as a structured approach for information storage and representation, employs triples (head entity, relation, tail entity) to organize factual knowledge, thereby achieving effective capture of entities and the complex relationships among them. This technology has found extensive application in knowledge-intensive tasks, such as intelligent question answering, recommendation systems, and semantic search. In comparison, common question-answering systems often face challenges such as low query efficiency, outdated knowledge updates, and limited expressiveness when dealing with knowledge-rich domains. Knowledge graphs leverage the associations between nodes to provide in-depth information retrieval and inference support, making them a key technology for addressing these challenges.

In recent years, large language models (LLMs) have achieved remarkable advancements in natural language processing, demonstrating robust capabilities in semantic comprehension and language generation. However, training these models requires extensive computational resources, and the pre-training process is both time-consuming and costly, limiting their adaptability to rapidly changing knowledge domains. Furthermore, LLM-generated content may exhibit “hallucination”, where, despite being grammatically correct, the content may contain factual inaccuracies or misleading information.

To address the aforementioned issues, the Retrieval-Augmented Generation (RAG) framework has been proposed and widely applied. By integrating precise information from external knowledge bases (e.g., knowledge graphs) into the inference process of the LLM, the RAG framework enhances the quality of contextual input and effectively mitigates hallucination-related issues. In question-answering systems, incorporating knowledge graph data into the generation workflow provides reliable evidential grounding for the LLM to perform inference, enabling more accurate and relevant responses. This approach is particularly suitable for tasks that involve large-scale and frequently updated knowledge sources.

However, existing RAG frameworks typically adopt a centralized knowledge graph architecture, restricting knowledge retrieval to a single data source. In real-world applications, knowledge graphs are often inherently distributed, particularly under federated learning paradigms, where domain-specific knowledge graph fragments are stored across multiple local-side computers. This distributed nature is structurally incompatible with the centralized architecture. The current solutions face the following systemic deficiencies:

First, low efficiency in multi-source retrieval. During cross-device graph traversal, common hardware architectures exhibit poor coordination between the data loader and the task decomposition unit, resulting in an imbalance between data loading and computational resource utilization. Specifically, large-scale graph queries may encounter on-chip memory overflows due to limited memory capacity, or suffer from idle computational resources caused by suboptimal granularity in subtask partitioning. Both issues significantly degrade retrieval performance.

Second, there is an inherent trade-off between privacy and efficiency. Existing privacy-preserving solutions rely predominantly on full data encryption or desensitization techniques. Although these methods effectively mitigate sensitive information leakage, they incur a 200%-300% increase in retrieval latency due to the computational overhead of encryption and decryption. Additionally, the lack of hardware-level differential privacy processing units prevents the system from simultaneously achieving entity-level privacy protection and millisecond-level response via Laplacian noise injection.

Third, a mismatch exists between static caching mechanisms and dynamic access patterns. The variation in access frequency among multi-source knowledge items renders common static caching schemes ineffective. Without co-optimization of hot-cold data tiered storage units and prefetch units, high-frequency knowledge items cannot be preferentially retained in SRAM. For example, as low-frequency data occupy more than 30% of SRAM storage resources, the system is forced to frequently access slower DRAM, thereby increasing query latency by 1.5 to 2 times.

For example, CN118364916A discloses a news retrieval method and system based on large language model (LLM) and knowledge graphs. The method comprises: acquiring multi-source news data and constructing a news database according to the multi-source news data; performing knowledge extraction on the multi-source news data in the news database using an initial large language model to obtain news entities and news relations, and constructing a news knowledge graph according to the news entities and news relations; integrating the news knowledge graph into the initial large language model using a knowledge fusion module to obtain a final large language model; and retrieving news content based on the final large language model to obtain news search results. This solution relies exclusively on a single knowledge graph for retrieval and thus exhibits the deficiencies described above.

The present disclosure aims to provide a system and method for federated knowledge retrieval and large language model enhancement based on a novel mechanism, incorporating a differential privacy protection mechanism to improve LLM inference performance and multi-source knowledge retrieval efficiency.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

However, most existing RAG frameworks rely on a single knowledge graph, restricting knowledge acquisition. In practical applications, knowledge graphs are typically distributed. Under federated learning scenarios, domain-specific knowledge graphs may be fragmented across multiple local-side computers. As a result, existing RAG frameworks face significant limitations in efficiently querying and integrating distributed, multi-source knowledge graphs, and lack sufficient consideration for privacy protection and computational efficiency.

To address the deficiencies of the existing art, the present disclosure provides, in a first aspect, a system for federated knowledge retrieval and large language model (LLM) enhancement, wherein the system includes a server and hardware accelerators. The server is configured to preprocess an input query to extract a central term and retrieve the central term through its caching module. Upon a cache hit, the caching module provides a query result corresponding to the central term to a data processor for a large language model to perform inference and generate an augmented response. Upon a cache miss in the caching module, the server sends a retrieval instruction to the hardware accelerators to perform retrieval in each hardware accelerator's local cache. Upon a further cache miss in the local cache, the hardware accelerators invoke a local knowledge graph, partition the local knowledge graph to generate parallel subtasks associated with the central term to perform a deep search, and inject noise into knowledge items retrieved by the parallel subtasks to protect sensitive information. The hardware accelerators integrate the noise-injected knowledge items and send them to the data processor through the caching module for the LLM to perform inference and generate an augmented response.

Through the coordinated operation of a server-side caching module and hardware accelerators, the present disclosure implements a two-level dynamic caching system. This design effectively minimizes cross-device communication by prioritizing query responses via a local high-frequency cache, thereby reducing the overall network load of the system. In the event of a cache miss, the hardware accelerators parallelize task execution using a knowledge graph partitioning algorithm, fully leveraging the parallel processing capabilities of dedicated hardware and significantly improving task throughput in complex query scenarios.

Additionally, in the federated learning framework, the present disclosure adopts a dynamic noise injection mechanism to apply privacy-preserving processing to retrieval results. By leveraging differential privacy techniques, the method protects sensitive information while preserving knowledge usability, ensuring compliance with international data security standards throughout the knowledge graph processing workflow. A knowledge graph partitioning strategy further confines data processing to local nodes, protecting raw data from exposure. The distributed management of local knowledge graphs effectively reduces the load on the central node, and, in conjunction with a task scheduling algorithm, facilitates dynamic resource allocation adaptable to application scenarios of different scales.

According to a preferred embodiment, each hardware accelerator comprises a data loader, a computation module, a differential privacy processing unit, and a result aggregation unit. The data loader is configured to acquire data from a local knowledge graph in batches and partition the knowledge graph into a plurality of data blocks sized to fit the hardware accelerator's on-chip memory. The computation module is configured to perform parallel computation. The differential privacy processing unit is configured to inject noise into sensitive data during processing to ensure data privacy. The result aggregation unit is configured to aggregate output information from a plurality of computation units in the computation module and perform analysis and processing to ensure the completeness and consistency of a final result.

The data loader employs a block-based loading strategy implemented with an on-chip memory, enabling efficient reuse of memory resources by dynamically partitioning data sizes. This approach significantly mitigates I/O bottlenecks and access latency during large-scale knowledge graph processing. The computation module features a parallel architecture that optimizes thread scheduling for irregular access patterns inherent in graph-structured data, effectively improving throughput in tasks such as entity-relation inference and graph embedding computation. Compared to common serial approaches, the disclosed system is more suitable for high-dimensional feature processing.

Furthermore, the differential privacy processing unit achieves temporal and spatial optimization of the noise injection mechanism at the hardware level. A dynamically adjustable privacy budget allocation strategy is employed to minimize distortion to analytical outcomes while adhering to (ε,δ)-differential privacy constraints. The pipeline architecture of the present disclosure enables seamless integration of the privacy protection process within the computation process, eliminating the privacy leakage risks and performance loss associated with common software-based implementations. The result aggregation unit performs consistency verification during the integration of parallel computation results by leveraging distributed redundant computation and an adaptive weight allocation algorithm, ensuring the statistical properties of the final output align with theoretical expectations.

According to a preferred embodiment, the data loader further comprises a task decomposition unit configured to, during data loading, search the central term of a query in all partitioned subregions of the knowledge graph, facilitating rapid task execution.

Specifically, the task decomposition unit of the present disclosure employs a distributed retrieval mechanism to map the central term of a query task to partitioned subregions of a knowledge graph for parallel search operations. This architecture provides three core advantages: (1) a spatial partitioning strategy transforms a global search into localized searches, effectively reducing the computational complexity of individual search tasks; (2) by exploiting the local correlation properties of the knowledge graph, the system applies an optimized graph traversal algorithm within each subregion to minimize access to irrelevant nodes; and (3) the dynamically scalable modular architecture ensures retrieval efficiency by increasing subregions as the knowledge graph grows, preventing performance degradation typically observed in common global search approaches.

According to a preferred embodiment, each hardware accelerator further comprises an on-chip controller, which includes: a task dispatch unit configured to receive and distribute subtasks from a task queue to ensure a balanced workload among computation units in the computation module; an instruction decoder configured to translate high-level task instructions into hardware-specific operational instructions to direct the computation units to execute corresponding tasks; and a state management unit configured to monitor each module in real time and coordinate resource allocation to ensure correct task execution and system stability.

The task dispatch unit employs a dynamic load balancing algorithm to perform real-time scheduling based on the operational status of the computation units and task-specific characteristics, enhancing resource utilization. The instruction decoder builds a configurable instruction mapping table to translate abstract operation instructions into specific micro-operation sequences, ensuring both ease of use of programming interface at a higher level and efficient hardware execution at a lower level. The state management unit establishes a multi-dimensional monitoring framework configured to perform real-time collection and analysis of more than 20 runtime parameters, including computing core power consumption, thermal status, and instruction throughput. These, combined with a predefined resource configuration strategy, enable adaptive response to abnormal operating conditions. The cooperation of these three control layers allows the system to maintain over 95% peak computational throughput while limiting the task execution error rate to 10-6 or below.

According to a preferred embodiment, each hardware accelerator further comprises a prefetch unit configured to predict potential data requirements based on historical access patterns and prefetch data from nodes in a knowledge graph using a Markov chain model to preload the data and reduce query latency. The prefetch unit utilizes the Markov chain model to proactively load potentially accessed path data from the data loader into a global memory of the computation module within the hardware accelerator prior to the initiation of a query task. This preloading mechanism mitigates performance bottlenecks associated with data access latency during query execution, enhancing query efficiency.

According to a preferred embodiment, the prefetch unit of each hardware accelerator predicts nodes likely to be accessed during query processing based on a Markov chain model. Prior to query initiation, the Markov chain model is constructed based on historical access patterns, and a node access path is predicted using the Markov chain model. This predictive capability enables the system to proactively prepare query-related data in advance, allowing immediate access when needed, thereby significantly enhancing system responsiveness.

According to a preferred embodiment, the server comprises a data processor and a caching module. The data processor is configured to extract a central term, run a coarse search program, and send the extracted central term to the caching module. The caching module is configured to search for a corresponding knowledge item. If a knowledge item corresponding to the central term exists, the caching module directly returns a query result to enter an augmented response phase, wherein the query result comprises neighbors of the central term. The data processor is configured to convert the query result to text and input the text to a large language model (LLM) for inference to generate an augmented response.

In the present disclosure, the coarse search program extracts the central term and performs a preliminary retrieval via the data processor, avoiding the high computational overhead associated with direct invocation of an LLM. The caching module implements a knowledge pre-storage mechanism that enables reuse of structured knowledge graph data in response to recognized historical query patterns, reducing redundant computation by approximately 30-50% compared to common end-to-end processing. The LLM is selectively activated only for valid queries with cache-hit results during the augmented response phase, and a dynamic resource allocation mechanism improves the computational efficiency of high-precision models by over 20%. This hierarchical processing strategy ensures result accuracy while significantly minimizing compute consumption per query.

Moreover, the query results returned by the caching module are constructed from the neighborhood node network of the knowledge graph. This design offers two key advantages. First, by exploiting the topological structure of the graph to identify related entities, the system improves result relevance by over 15% compared to common keyword matching. Second, the data processor transforms the graph into a semantically rich text sequence by retaining edge attributes (e.g., relation types and connection weights), increasing the semantic density of the LLM input by approximately 40% and significantly improving the coherence and factual accuracy of the generated responses.

According to a preferred embodiment, the processing steps of the data processor in the server further include: upon finding no relevant knowledge items during a coarse search, sending deep search requests to local-side computers through the Internet; each local-side computer receiving the query request from the server through a network adapter and running a deep search program based on the query request; and the deep search program accessing a hardware accelerator chip through a high-speed bus, enhancing knowledge retrieval efficiency.

When the caching module reports a cache miss, a deep search request and its corresponding protocol are triggered. The data processor encapsulates the query into a standard data packet and distributes it to local nodes using a load-balancing algorithm, reusing the scheduling strategy of the task dispatch unit to optimize network throughput. Each local-side computer activates the on-chip controller in the hardware accelerator to manage the task queue, where the instruction decoder compiles the deep search program into micro-instructions. By leveraging a high-speed bus directly connected to the accelerator and the parallel execution of subtasks coordinated by the task dispatch unit, the system efficiently performs graph traversal.

In a second aspect, the present disclosure provides a method for federated knowledge retrieval and large language model (LLM) enhancement, wherein the method include the followings steps: preprocessing an input query by a server to extract a central term; retrieving the central term through a caching module of the server, wherein upon a cache hit, the caching module provides a query result corresponding to the central term to a large language model for inference to generate an augmented response; upon a cache miss in the caching module, sending a retrieval instruction from the server to hardware accelerators to perform retrieval in each hardware accelerator's local cache; upon a further cache miss in the local cache, invoking a local knowledge graph by the hardware accelerators, partitioning the local knowledge graph to generate parallel subtasks associated with the central term for performing a deep search, and injecting noise into knowledge items retrieved by the parallel subtasks to protect sensitive information; and integrating the noise-injected knowledge items by the hardware accelerators and sending them through the caching module to a data processor for the LLM to perform inference and generate an augmented response.

The disclosed method offers the following advantages: with accurate identification of the central term during preprocessing, the caching module achieves a hit rate of up to 85%, allowing 68.5% of query requests to be resolved entirely at the server level, avoiding resource consumption at the hardware accelerators. This feedforward optimization strategy reduces overall system resource consumption by approximately 32% while maintaining sub-second responses for high-frequency queries.

Upon receiving a request, the hardware accelerators apply a dynamic partitioning algorithm to the knowledge graph to optimize the compute-to-communication ratio through task granularity control: fine-grained partitions are tailored to parallel computation units, while a semantic community-based aggregation strategy mitigates communication overhead induced by data fragmentation. The differential privacy module performs streaming noise injection during subtask generation, completing noise overlay and avoiding the 30-40% latency overhead typical of post-processing. This proactive privacy protection enables spatiotemporal alignment between data processing and security, boosting system throughput by 22.5% while preserving 86.7% semantic fidelity.

According to a preferred embodiment, the local cache employs a hot-cold data dual storage mechanism to enhance retrieval efficiency, comprising: storing cold data and hot data in different types of storage media; monitoring access frequency or timestamps of data items; initiating a migration process when the access frequency of a data item exceeds a predetermined threshold; removing low-frequency data from a hot cache and storing it in a slower cold storage; and migrating frequently accessed data from the cold storage to the hot cache to ensure fast access.

The method of the present disclosure adopts a cold and hot data dual storage mechanism, in which frequently accessed data are preferentially retained in the hot cache to ensure optimal access speed, while infrequently accessed data are stored in the cold storage. As access frequencies change, the system periodically adjusts data placement, enabling timely migration of high-frequency data to the hot cache, reducing access latency and enhancing query efficiency.

### BRIEF DESCRIPTION OF THE DRAWINGS

FIG. 1 is a hardware architecture diagram of a system for federated knowledge retrieval and LLM enhancement according to the present disclosure;

FIG. 2 is a hardware structure schematic diagram of a server in the system according to the present disclosure;

FIG. 3 is a hardware structure schematic diagram of each local-side computer according to the present disclosure;

FIG. 4 is a logical schematic diagram of a hardware accelerator according to the present disclosure;

FIG. 5 is an overall flowchart of the system according to the present disclosure;

FIG. 6 is a flowchart of a deep search process of the system according to the present disclosure; and

FIG. 7 is a flowchart of differential privacy processing for the deep search according to the present disclosure.

### DETAILED DESCRIPTION OF THE APPLICATION

The present disclosure is described in detail below with reference to the accompanying drawings.

Certain terms used in this disclosure are defined as follows:

Federated Knowledge Retrieval: a specialized application of federated learning, enabling collaborative knowledge discovery and model training across multiple distributed data sources without exchanging raw data. This approach enhances model performance while preserving data privacy and ensuring system security.

Query: a request mechanism for retrieving targeted information from databases or other structured information storage systems, typically comprising user-provided keywords, phrases, or complex conditional expressions.

Prompt: input text provided to an AI model to guide it in generating or processing content according to the user's intent.

Large Language Model (LLM): a deep learning-based large-scale neural network capable of understanding and generating natural language text. An LLM is trained on massive text datasets and can perform a wide range of language tasks with near-human proficiency

Server-side Cache Module 120: a first-level cache stored on the server 100, serving as a temporary data storage area to hold frequently accessed data copies, reducing redundant computations and database queries to accelerate response speed.

Local Cache: a second-level cache stored on the client side, designed to hold recently or frequently used data, reducing dependence on the server 100 and improving application response time and user experience.

Graph Processing Module (GPM): a hardware or processing module designed to efficiently handle graph data, optimizing the storage and retrieval of graph structures.

Knowledge Graph: a structured form of knowledge representation using nodes to represent entities and edges to represent relationships between entities, forming a complex information network that supports advanced information retrieval and inference.

Retrieval-Augmented Generation (RAG): a method combining common retrieval techniques with modern generative models to enrich generated content by retrieving relevant documents, improving the relevance and accuracy of the output.

Differential Privacy: a technique for protecting individual data privacy by injecting noise into the data analysis process, ensuring that the presence or absence of a single data entry does not significantly affect the overall result.

Cosine Similarity: a metric for measuring the directional similarity between two vectors, widely used in fields such as text analysis, evaluating similarity based on the cosine of the angle between vectors.

Hardware Accelerator 200: a hardware component, such as a GPU or TPU, designed to accelerate specific types of computation, such as matrix operations in machine learning or convolutional operations in image processing.

Data Loader 270: a module responsible for reading data from storage media and transferring it to processing modules in system memory, forming part of the data preprocessing pipeline.

Task Dispatch Unit 312: a mechanism that manages and distributes tasks to different computational units to enable parallel execution and load balancing for improved overall efficiency.

Task Queue: an ordered list of tasks used for scheduling execution, ensuring that higher-priority tasks are executed first.

Computation Module 290: a hardware or processing module that executes specific computational tasks, such as an arithmetic logic unit (ALU) in a CPU or a compute core in a GPU.

Result Aggregation: the process of consolidating results from multiple computation nodes to generate a final output.

BERT (Bidirectional Encoder Representations from Transformers): a pre-trained language model based on the Transformer architecture, leveraging bidirectional encoders to capture contextual information, demonstrating strong performance in various natural language processing tasks.

Hot-cold Data Dual Storage Mechanism (or Cold and Hot Data Dual Storage Mechanism): a data management strategy that stores frequently accessed “hot data” in high-speed storage media (e.g., cache) and less frequently accessed “cold data” in slower but more economical media to optimize storage resources and access latency.

SRAM (Static Random-Access Memory): a high-speed semiconductor memory using static memory cells to store data without requiring periodic refresh, typically used for cache and high-speed storage applications.

DRAM (Dynamic Random-Access Memory): a widely used main memory type in computing systems, storing data in capacitors that require regular refreshing to maintain data integrity, suitable for general-purpose memory applications due to its high density and low cost. Markov Chain Prediction Algorithm: a prediction method based on probabilistic transition matrices that uses the current state of a system to estimate the next state, commonly applied in time-series modeling and analysis of stochastic processes.

The present disclosure provides a system and method for federated knowledge retrieval and LLM enhancement, an apparatus for federated knowledge retrieval and LLM enhancement, and a processor for use in a system for federated knowledge retrieval and LLM enhancement.

Common RAG frameworks primarily rely on a single knowledge graph, limiting knowledge retrieval to a single data source. In practice, however, knowledge graphs are typically distributed, particularly in federated learning scenarios, where domain-specific knowledge is partitioned across multiple clients or edge devices. These limitations hinder existing RAG frameworks from efficiently querying and integrating distributed, multi-source knowledge graphs, with insufficient consideration for privacy protection and computational efficiency, leading to performance bottlenecks in large-scale graph data processing and querying.

Accordingly, enabling efficient retrieval and integration of multi-source knowledge graphs under privacy-preserving constraints constitutes a major challenge in advancing retrieval-augmented generation.

The present disclosure proposes a software-hardware co-designed system for federated knowledge retrieval and LLM enhancement. The core concept is as follows:

Through a software-hardware co-designed architecture, the data processor 110 and caching module 120 in the server 100 operate in conjunction with the hardware accelerators 200 to enable efficient federated knowledge graph retrieval and enhanced reasoning performance of the LLM, while ensuring data privacy through differential privacy techniques. Specifically, the disclosed system employs a multi-level caching mechanism, including server-side and local-side caches, to cooperate with the hardware accelerators 200 to optimize knowledge graph retrieval and accelerate query response while ensuring privacy protection throughout the retrieval process.

The basic operation of the disclosed system is as follows: First, a user's query is sent to the server-side caching module 120 for a preliminary check to determine whether the required information can be retrieved directly, avoiding redundant computation. If further retrieval is needed, the request is forwarded to the hardware accelerators 200, which execute complex graph-based data processing tasks. After completing the deep search, the hardware accelerators 200 return the results to the caching module 120, where knowledge snippets from multiple sources are aggregated and organized. The consolidated knowledge is then processed by the data processor 110 and provided to the LLM as augmented input for generating more accurate responses.

This design improves both retrieval efficiency and response quality while enhancing user data security through techniques such as differential privacy. The resulting solution is efficient and secure, making it particularly suitable for knowledge graph applications spanning multiple distributed data sources, offering robust support for real-time information access and large-scale data analysis.

### Embodiment 1

The system for federated knowledge retrieval and LLM enhancement of the present disclosure comprises a server 100, which includes at least a data processor 110, a caching module 120, and hardware accelerators 200. A user side 240 is connected to the server 100 through an I/O adapter 210. The I/O adapter 210 is connected to the server 100 through a high-speed bus 310 and configured to process external input/output operations. A network adapter 220 is connected to the server 100 through the high-speed bus 310 and configured to communicate with the Internet or other computers, particularly with local-side computers 400 through the Internet.

Preferably, the central processing unit (CPU) of the server 100 is connected to a main memory (RAM) 230 through the high-speed bus 310. The RAM 230 stores key modules, such as data processing programs and coarse search programs, associated with the data processor 110.

Additionally, the caching module 120 is connected to the high-speed bus 310 and configured to store recently used or frequently accessed data, reducing RAM 230 access frequency and accelerating data retrieval.

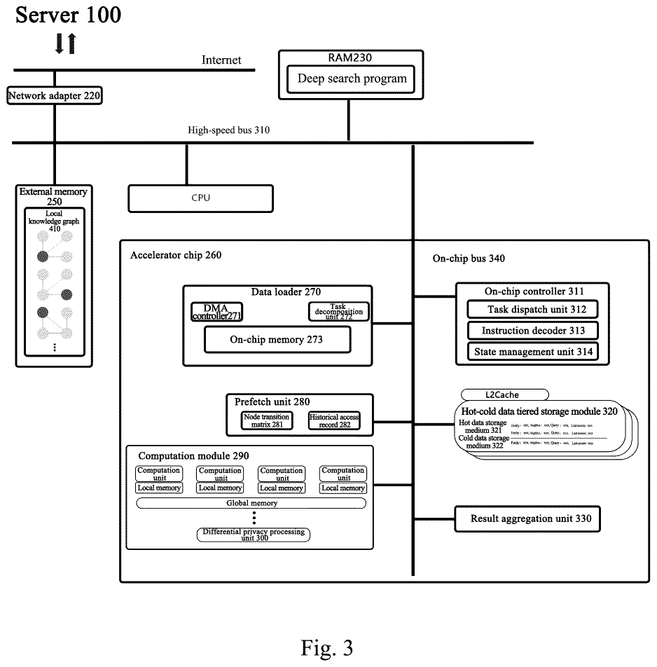

Preferably, as shown in FIG. 3, each hardware accelerator 200 comprise an accelerator chip 260, a CPU, a RAM, a network adapter 220, and an external memory 250. The accelerator chip 260 comprises multiple functional modules configured to accelerate data processing and computation tasks. The hardware accelerators 200 are deployed to individual local nodes, which may also be referred to as a user side 240 or a client side.

As shown in FIG. 3, the network adapter 220 is configured to acquire data from external networks and local knowledge graphs 410 and send the data to the CPU and the RAM 230 through the high-speed bus 310. The RAM 230 stores modules, such as deep search programs. The CPU is connected to the RAM 230 and configured to execute program instructions and process the data stored in the RAM 230.

The accelerator chip 260 integrates multiple submodules, including an on-chip controller 311, a data loader 270, a task dispatch unit 312, a computation module 290, a differential privacy processing unit 300, and a result aggregation unit 330. As shown in FIG. 3, each hardware accelerator 200 is composed of numerous key components and configured to store local personalized knowledge, executing graph retrieval efficiently while preserving privacy.

As shown in FIG. 3, in the present disclosure, the accelerator chip 260 of the hardware accelerator employs a multi-layer on-chip bus architecture to enable inter-module communication and data coordination among the functional modules. The on-chip bus 340 in FIG. 3 is a highly optimized system-on-chip interconnect architecture.

The on-chip bus 340 is configured in a hierarchical topology and partitioned into two physical channels: a high-performance computing bus and a general-purpose control bus. The high-performance computing bus is configured as a 256-bit bidirectional transmission channel operating at a frequency synchronized with that of the computation module, dedicated to high-throughput data transfers among the computation module, the data loader, and the global memory. The general-purpose control bus is configured as a 64-bit time-division multiplexed bus adapted to convey control signals and status information exchanged between modules.

The on-chip bus architecture adopts a master-slave access mechanism, wherein the on-chip controller 311 acts as the master device with the highest arbitration priority. The task decomposition unit 272 sends task configuration parameters and instruction streams to the task dispatch unit 312 via the general-purpose control bus to implement dynamic bandwidth allocation. The data loader 270, the computation module 290, the differential privacy processing unit 300, and the result aggregation unit 330 are connected to the on-chip bus 340 as slave devices through on-chip bus interface units.

The connection relationship of the on-chip bus 340 is as follows:

The task decomposition unit 272 sends task configuration parameters and instruction streams to the task dispatch unit 312 via the general-purpose control bus.

The data loader 270 has a DMA controller 271 directly connected to the high-performance computing bus to form a burst-mode data path toward the global memory of the computation module 290.

The computation module 290 comprises computation units, each with its own local memory, and further comprises a global memory. The graph processing modules (GPMs) in the computation module 290 are connected to the on-chip bus 340 via dual channels through their interface unit, wherein a computation instruction channel is connected to the general-purpose control bus, and the data channel is directly connected to the high-performance computing bus.

A prefetch unit 280 captures access pattern data of a node transition matrix 281 through a monitoring mechanism of the on-chip bus 340 and injects prefetched data during idle intervals of the on-chip bus 340.

The differential privacy processing unit 300 is interposed as a bridging component via the on-chip bus 340, enabling real-time noise injection along the data transmission path between the computation module 290 and the result aggregation unit 330.

The result aggregation unit 330 is configured on the on-chip bus 340 as a dual-mode device that operates either as a master or a slave, receiving output data streams from the computation module 290 and reporting system status to the on-chip controller 311 via the same bus.

The on-chip bus architecture combines physical-layer timing optimization with protocol-layer intelligent scheduling to resolve bus contention under concurrent module access, providing a reliable interconnection infrastructure for the coordinated operation of hardware accelerator components.

The data loader 270 is connected to the external memory 250 via the on-chip bus 340 and the high-speed bus 310 and configured to batch-load data from the local knowledge graph 410. The data loader 270 is further connected to a DMA controller 271, which enables efficient data transfer to the hardware accelerator 200, reducing latency. The DMA controller 271 is connected to the knowledge graph stored in an off-chip memory and to the on-chip memory 273 of the hardware accelerator 200, allowing direct and efficient data transmission without involving the central processing unit (CPU). The on-chip controller 311 is connected to the task dispatch unit 312, the instruction decoder 313, and the state management unit 314, respectively, and is responsible for coordinating and managing allocation and execution of computation tasks.

Preferably, to support efficient data storage and access, each hardware accelerator 200 integrates a high-speed local cache constructed using static random-access memory (SRAM), ensuring rapid data retrieval during different phases of computation.

Preferably, the DMA controller 271 in the data loader 270 is configured to batch-load data from the local knowledge graph 410 and provide the required information to the hardware accelerator 200 through an optimized data transmission channel, reducing latency. The DMA controller 271 is responsible for direct and deficient data transmission between the knowledge graph in the external memory 250 and the on-chip memory 273 of the hardware accelerator 200 without involving the local-side CPU.

Specifically, the data loader 270 partitions the knowledge graph stored in the external memory 250 into multiple data blocks sized to fit the on-chip memory 273 of the hardware accelerator 200, each containing a portion of the graph structure, including nodes and edges. The data loader 270 further comprises a task decomposition unit 272 configured to process the central term of each query during data loading, enabling corresponding searches across all subregions of the partitioned knowledge graph.

Preferably, the hardware configuration of the on-chip controller 311 comprising a task dispatch unit 312, an instruction decoder 313, and a state management unit 314. The task dispatch unit 312 is responsible for receiving and assigning subtasks from the task queue to ensure a balanced workload across computation units of the computation module 290. The instruction decoder 313 converts high-level task instructions into hardware-specific operational instructions that direct the relevant modules to perform corresponding tasks. The state management unit 314 performs real-time monitoring of the modules' operation and coordinate resource allocation, ensuring correct execution of tasks and stable system performance.

As shown in FIG. 3, the task dispatch unit 312 is configured to receive and parse requests from the task queue, partition each task into parallelizable subtasks, and assign the subtasks to corresponding computation units within the computation module 290, improving overall processing efficiency. The task dispatch unit 312 dynamically distributes computation tasks to achieve parallel execution and load balancing.

The computation module 290 comprises multiple custom graph processing modules (GPMs), each serving as a computation unit configured to provide highly parallel processing capability for handling complex graph data. Each computation unit is equipped with a local memory and operably connected to the global memory within the computation module 290 to enable data exchange. This architectural design provides the basis for the subsequent operation of the prefetch unit 280.

The differential privacy processing unit 300 is configured to ensure data privacy by injecting noise into sensitive data during processing. Implemented as a hardware logic block embedded in the computation module 290, the differential privacy processing unit 300 executes privacy protection algorithms in real time upon the completion of each query subtask. The differential privacy processing unit 300 is operably connected to the result aggregation unit 330.

The result aggregation unit 330 is configured to aggregate the outputs from the computation units and perform integrated analysis and processing to ensure completeness and consistency of the final result. Moreover, the result aggregation unit 330 is implemented with a high-performance processor to maintain rapid responsiveness under high workload conditions.

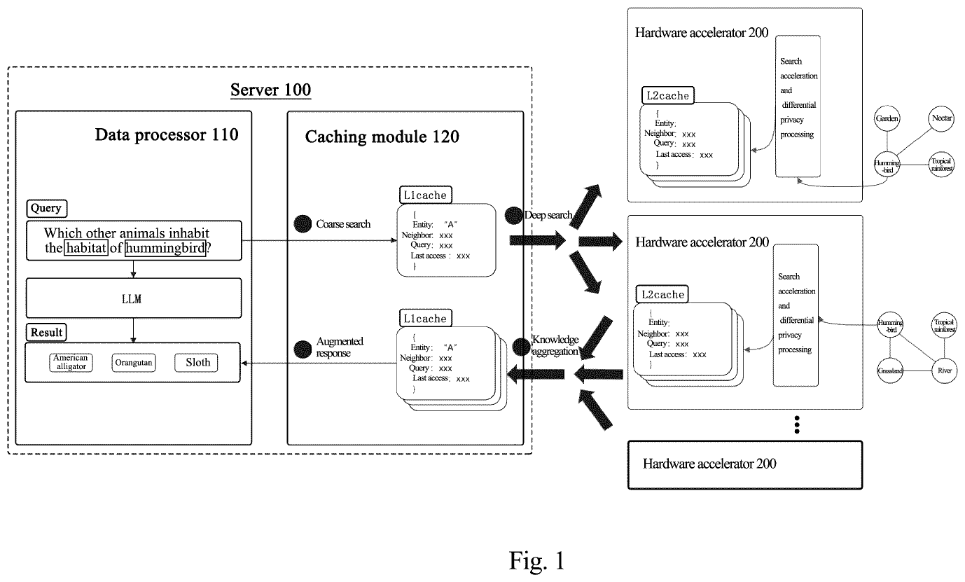

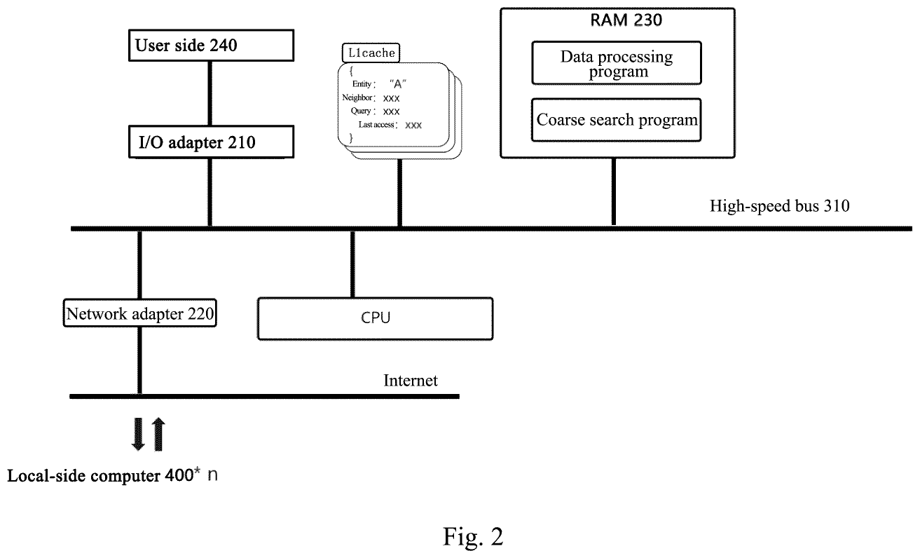

As illustrated in FIG. 1, an exemplary embodiment is presented based on the system architecture and operational flow of the hardware accelerator 200 of the present disclosure. Referring to FIGS. 1 and 2, the system comprises a server 100 and a plurality of local-side computers 400. The server 100 may be implemented using multiple computers and may alternatively be referred to as a server-side computing device. These components are network-connected to cooperatively support efficient knowledge retrieval and reasoning capabilities.

The server 100 is configured with a data processor 110 and a caching module 120. Upon receiving n query requests from a user at the server-side computing device, the data processor 110 extracts central terms from the respective queries. A coarse search program is then executed, wherein the central terms are transmitted to the caching module 120 to determine whether corresponding knowledge items exist. If a matching knowledge item is found, the caching module 120 directly returns the query result to enter an augmented response phase. The query result comprises neighbors of the central term, which are textualized by the data processor 110 and provided to the large language model (LLM) to perform reasoning and generate an augmented response.

When the coarse search fails to locate a relevant knowledge item, the server 100 transmits a deep search request over the Internet to each local-side computer 400. Each local-side computer 400 comprises a network adapter 220 configured to receive the query request. Upon reception, the deep search program executed by the local-side computer 400 accesses the accelerator chip 260 of the hardware accelerator 200 via the high-speed bus 310.

FIG. 3 illustrates the internal structure of the accelerator chip 260 included in the hardware accelerator 200. The accelerator chip 260 incorporates an on-chip controller 311 configured to decode instructions and control data flow.

First, the local-side computer 400 executes a deep search program to retrieve the knowledge item associated with the central term from the local cache. If the item is found, the result is returned to the server-side computer directly. Otherwise, the data loader 270 of the accelerator chip 260 partitions the knowledge graph stored in the external memory 250 into multiple data blocks sized to fit the on-chip memory 273 of the hardware accelerator 200, each comprising a portion of the graph structure, such as nodes and edges. This block-wise partitioning enables efficient storage and processing of the data in the on-chip memory 273. During data loading, the data loader 270 also decomposes each query task based on its central term, ensuring that searches are performed across all partitioned subregions of the knowledge graph. Each search constitutes an individual subtask, which retains the central term and is dispatched to the task queue to await processing based on its priority.

The tasks stored in the task queue are delivered to the computation module 290 via the task dispatch unit 312. The computation module 290 comprises multiple computation units configured to perform graph query operations for the subtasks in parallel. The resulting outputs of these subtasks are processed by a differential privacy processing unit 300 disposed on the computation module 290, which injects noise to protect sensitive information and preserve user privacy. The processed results are then forwarded to the result aggregation unit 330, which is configured to consolidate the subtask results, eliminate duplicates, and ensure output completeness.

Upon completion of the deep search performed by the hardware accelerators 200 of the respective local-side computers 400, the resulting query data is aggregated at the caching module 120. The caching module 120 is configured to merge and organize the retrieved results from multiple sources, ensuring data consistency and completeness. Finally, the merged knowledge data is transmitted to the data processor 110 to enhance the answering capability of the LLM.

### Embodiment 2

This embodiment further elaborates on Embodiment 1, omitting redundant descriptions.

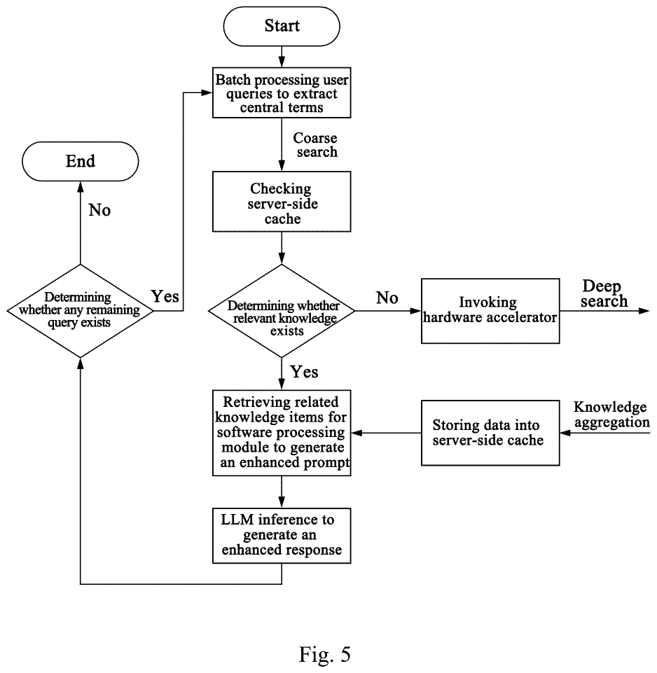

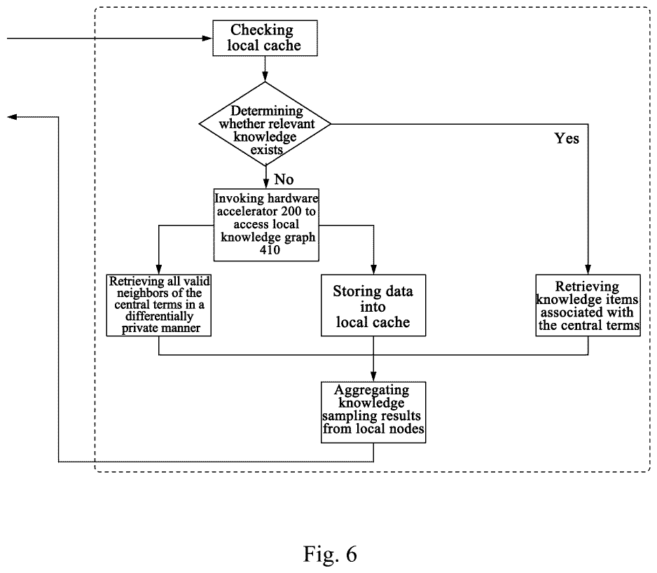

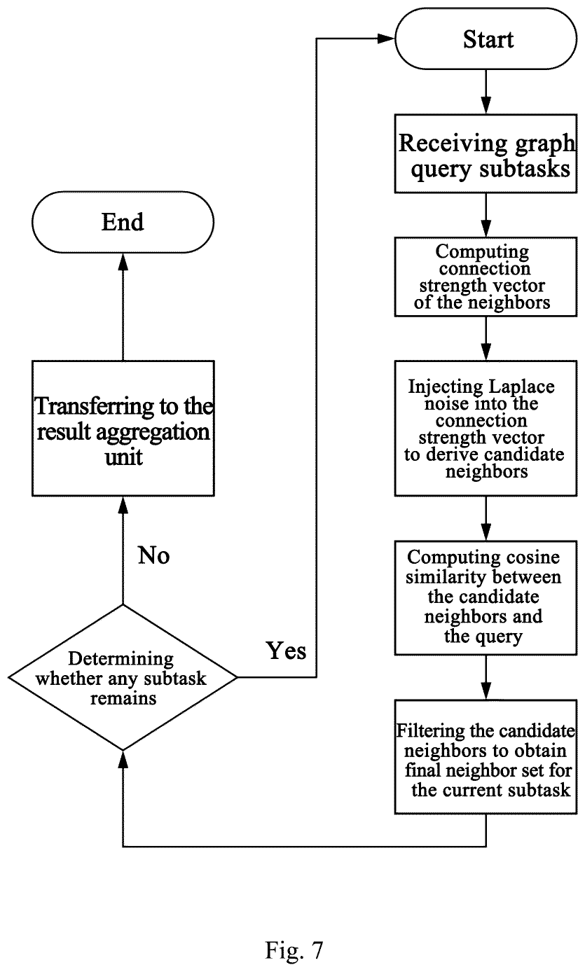

Preferably, a method for federated knowledge retrieval and large language model (LLM) enhancement provided by the present disclosure comprises steps as illustrated in FIGS. 1, 4, 5, 6 and 7. These steps are implemented in five phases: query preprocessing, coarse search, deep search, knowledge aggregation, and augmented response. FIGS. 6 and 7 detail the process shown in FIG. 5.

As shown in FIG. 5, the method of the present disclosure includes the following steps:
S001: Process user queries in batches, extract central terms, and perform coarse searches;
S002: Check the server-side to determine whether relevant knowledge exists;
S003: In response to a cache miss, invoke the hardware accelerators 200 to perform a deep search;
S004: In response to a cache hit, acquire a related knowledge item from the cache and provide it to the data processor 110 to generate a prompt;
S005: Perform LLM inference based on the prompt to generate an enhanced response;
S006: Determine whether any remaining query exists; if so, return to step S001; if not, end the process;
S007: Store the knowledge aggregation result in the server-side cache.

The five phases of the present disclosure are detailed below.

In the query preprocessing phase S100, an input query is preprocessed to extract its central term.

As illustrated in FIG. 1, the data processor 110 of the server 100 processes n user queries accumulated over a period in batch. For each query (i.e., query request), the data processor 110 analyzes the current input query qᵢ, where i∈[1,n], to identify several core terms with the highest information value, denoted as central terms c_{q}. This process includes segmenting the query text, eliminating stop words, and identifying key terms.

For example, consider the input query qᵢ: “Which regions in China are the primary habitats of giant pandas?”

First, the data processor 110 utilizes an open-source natural language processing toolkit, the Natural Language Toolkit (NLTK), to segment the query into constituent words or phrases. NLTK efficiently tokenizes the input text, for example, segmenting the query into: “Which|regions|in|China|are|the|primary|habitats|of|giant|pandas”. Subsequently, the data processor 110 applies NLTK's built-in stop word list to eliminate non-informative terms, such as “primary”, “in”, “of” and “regions”. Thereafter, the data processor 110 employs BERT to perform keyword identification across the entire query, extracting “giant panda” and “China” as the central terms c_{q}.

As another example, for the user query “Which other animals inhabit the habitat of hummingbird?”, the data processor 110 initially uses he Natural Language Toolkit (NLTK), an open-source natural language processing toolkit, to segment the query into: “Which|other animals|inhabit|the|habitat|of|hummingbird”. Subsequently, the data processor 110 applies NLTK's built-in stop word list to remove non-informative terms, including “of”, “other”, “Which”, and “animals”. Thereafter, Bidirectional Encoder Representations from Transformers (BERT), a pre-trained language model, performs keyword identification across the sentence, extracting “hummingbird” and “habitat” as the central terms c_{q} and leveraging bidirectional contextual analysis to generate context-sensitive word embeddings. During keyword identification, BERT assigns an importance score to each term based on its contextual relevance and selects a user-configurable number of top-ranked terms with the highest scores as the central terms c_{q}.

During keyword identification, BERT computes an importance score for each word by generating a context-aware word vector, a high-dimensional representation of a word or phrase used that captures its semantic meaning and contextual relationships.

BERT employs an attention mechanism to compute attention weights between each word and all other words in the sentence.

The attention weight is calculated as follows:

$${α}_{ij} = \frac{exp ( {Q}_{i} \cdot {K}_{j} )}{{\sum }_{k} exp ( {Q}_{i} \cdot {K}_{k} )} ,$$

where Qᵢ is the query vector of word i, Kⱼ is the key vector of word j, and αᵢⱼ denotes the attention weight of word i with respect to word j.

BERT determines the final importance score of each word by computing an attention score and performing a weighted average over contextually relevant word vectors. Subsequently, BERT outputs a set of top-ranked words with the highest importance scores as the central terms. Words with higher importance scores indicate greater semantic contribution within the query.

BERT's word vector representations and attention mechanism enable accurate keyword extraction based on the contextual semantics of a query, overcoming the limitations of common methods. By dynamically adapting the representation of each word, BERT captures subtle semantic variations and identifies the most informative terms within the query, enhancing query accuracy.

Extracting central terms highlights the query's focus, providing a clearer direction for subsequent knowledge retrieval and inference. The central terms c_{q} are transmitted by the data processor 110 to the caching module 120 for a coarse search, enabling and supporting subsequent knowledge retrieval and inference processes.

In the coarse search phase S200, retrieval for the central term is conducted during the caching process. If there is a cache hit, the result is directly forwarded to the data processor 110; if there is a cache miss, retrieval is carried out from the local cache.

As illustrated in FIG. 1, during the coarse search phase, the caching module 120 responds to a query request from the data processor 110 by determining whether a central term c_{q} has been previously stored. The data in the caching module 120 is organized in a json format, as shown in FIG. 1, comprising entities, neighbors, the original query processed at the time of caching, and a timestamp indicating the last access to the corresponding knowledge item. The caching module 120 matches the entity name of the central term c_{q} against all cached entries to retrieve a corresponding knowledge item. If a knowledge item K_{L1} associated with the central term is found in the caching module 120, it is directly returned as the query result and forwarded to the augmented response phase. If no valid result is found in the caching module 120, the data processor 110 redirects the query to local caches (L2 Cache) in the hardware accelerators 200 of each local-side computer for a deep search.

Upon receiving a deep search request from the caching module 120, the hardware accelerators 200 enter the deep search phase.

In the deep search phase S300, if the local cache still yields no hit, each hardware accelerator 200 accesses a corresponding local knowledge graph 410 to perform a deep search. Subsequently, the differential privacy processing unit 300 injects noise into each candidate knowledge item retrieved during the process to protect sensitive information. The noise-injected deep search results are then stored in the caching module 120.

The deep search phase includes the step illustrated in FIG. 6.
Step S310: Check the local cache to reduce access to the local knowledge graph 410.

This is determined by the difference in access speed between the local cache and the local knowledge graph 410. Specifically, query access to the local cache is significantly faster than query access to the local knowledge graph 410. The local cache in the hardware accelerator 200 is configured to store personalized knowledge items, which arise from the distributed nature of knowledge storage and privacy protection mechanisms, resulting in knowledge entries with personalized characteristics at each local node.

The hardware accelerator 200 receives the central term c_{q} from the caching module 120 and queries data in the local cache. Specifically, the hardware accelerator 200 utilizes the hot-cold tiered storage module 320 to query a corresponding knowledge item from the local cache based on the entity name of the central term c_{q}.
Step S320: Determine whether relevant knowledge exists.
In step S321: if relevant knowledge K_{L2} is found in the local cache, the hardware accelerator 200 retrieves a knowledge item associated with the central term of the query and returns the result to enter the knowledge aggregation phase.
In step S322: if no such knowledge is found, the hardware accelerator 200 accesses the local knowledge graph 410.

In response to a miss at the local cache, the hardware accelerator 200 accesses the local knowledge graph 410. The local knowledge graph 410 contains neighbor relationships among entities and semantic information, serving as the primary knowledge source for the LLM to generate augmented responses. The hardware accelerator 200 performs multiple graph query tasks in parallel, thereby reducing overall computation time.
Step S330: Retrieve all valid neighbors of the central term in a differentially private manner and in parallel, and store the resulting data in the local cache.
Step S340: Aggregate the knowledge sampling results from each local node.

Preferably, as shown in FIG. 3, the hot-cold data dual storage mechanism of the hot-cold data tiered storage module 320 serves as a data management strategy for the local cache. This mechanism classifies data into hot and cold categories according to access frequency and importance, storing them in different storage media. Hot data, which is frequently accessed and updated, is stored in a hot data storage medium 321, namely SRAM. SRAM offers high access speed and is typically used for the high-speed tier of the cache. Cold data, which is less frequently accessed, is stored in a cold data storage medium 322, namely DRAM. DRAM provides higher storage capacity with relatively slower access speed and is typically used for the low-speed tier of the cache. This hot-cold data dual storage mechanism significantly enhances cache access efficiency and overall system performance. By storing frequently accessed hot data in the high-speed SRAM (hot data storage medium 321), the system reduces query latency and ensures rapid access to critical data, optimizing access performance. Conversely, low-frequency cold data is stored in the high-capacity DRAM (cold data storage medium 322), enabling efficient resource allocation without compromising storage capacity.

Common single-layer cache architectures often result in excessive server-side load when handling frequent knowledge retrieval requests. Additionally, the inability to leverage local storage resources leads to increased data transmission latency and reduced query efficiency. In contrast, the hot-cold data dual storage mechanism addresses these issues through hierarchical knowledge management. The server caches frequently accessed and general knowledge, while the local node focuses on caching personalized knowledge. This design prioritizes local cache queries, reducing server dependency and minimizing data transmission and query response time. Moreover, the mechanism ensures that frequently accessed data remains in the local cache, improving data reuse and maximizing knowledge utilization efficiency, thereby significantly enhancing overall system performance and responsiveness.

Preferably, when a change in data access frequency is detected, the hardware accelerator 200 utilizes a preconfigured prefetch unit 280 to trigger data migration based on historical access records 282 and data importance, dynamically adjusting the partitioning between hot and cold data to maintain efficient operation under varying workloads.

The prefetch unit 280 predicts and loads data nodes likely to be accessed during query execution, reducing access latency and enhancing overall system performance. As shown in FIG. 3, the prefetch unit 280 comprises a node transition matrix 281 and historical access records 282.

The node transition matrix 281 analyzes access relationships between nodes and predicts nodes likely to be accessed during query execution based on hardware-level logic. The historical access records 282 stores node access trajectories from prior queries.

The prefetch unit 280 monitors access frequency or timestamps for each data item based on the historical access records 282. When the access frequency of a data item exceeds a predetermined threshold, the prefetch unit 280 initiates a data migration process. Low-frequency data is removed from the hot data storage medium 321 and stored in the cold data storage medium 322, which has slower access speed. Conversely, frequently accessed data is migrated from the cold data storage medium 322 to the hot data storage medium 321 to ensure fast access. The migration process is controlled by the prefetch unit 280 to ensure efficient and low-latency data relocation.

As described above, the hardware accelerator 200 improves cache locality, reducing cache miss occurrences and enhancing data loading efficiency.

This optimization not only improves query responsiveness and reduces memory overhead but also enables higher throughput and lower power consumption.

Preferably, to reduce data loading latency, the node transition matrix 281 uses a Markov chain-based prediction algorithm to predict nodes likely to be accessed during the query process.

Specifically, prior to query execution, the node transition matrix 281 constructs a Markov chain model based on historical access patterns to predict the next node access paths. The Markov chain prediction algorithm is a probability model based on historical state transitions, predicting the future state of a system based on its current state, assuming independence from prior states.

As shown in FIG. 3, before each subtask starts, the node transition matrix 281 analyzes historical access records and constructs a Markov chain model based on subregions R₁, R₂, . . . , Rₖ derived from the partitioning of the knowledge graph.
S351: Collect historical access patterns.

Record access relationships between nodes: P(i→j), representing the transition probability from node i to node j. For example, the transition from node A to node B is denoted as P(A→B).
Step S352: Construct a Markov chain model.

The node transition matrix 281 computes the probability transition matrix P based on the historical access records. The transition process is expressed as:

$$P = [ \begin{matrix}P ( A \to A ) & P ( A \to B ) & … \\ P ( B \to A ) & P ( B \to B ) & … \\ ⋮ & ⋮ & ⋱\end{matrix} ] .$$

S353: Predict node access.

According to the current node X, predict the next node access path. The next node Y is determined by maximizing the transition probability P(X→Y):

$$Y = {argmax}_{Y} P ( X \to Y ) ,$$

where Y denotes the node with the highest transition probability from node X.

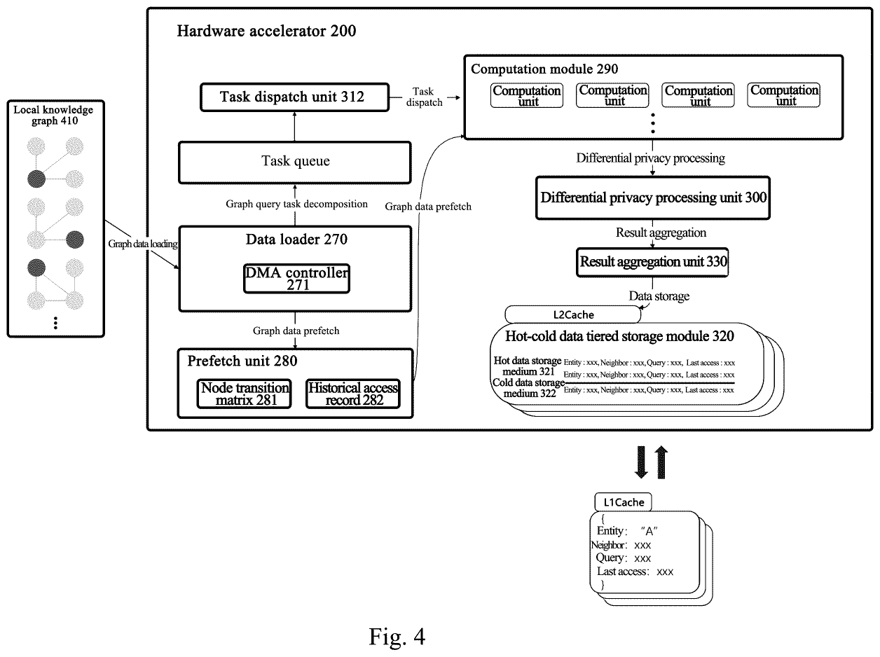

In practical operation, as illustrated in FIGS. 3 and 4, the prefetch unit 280 of the hardware accelerator 200 analyzes the historical access records 282 and the node transition matrix 281 to construct a Markov chain model, predicting likely graph node paths during the query. Using this model, the prefetch unit 280 preloads predicted path data from the data loader 270 into the global memory of the computation module 290 before the query task starts. This loading mechanism mitigates performance bottlenecks due to data access latency, enhancing overall query efficiency.

The Markov chain model achieves this by modeling node access patterns through a probability transition matrix, enabling the computing module 290 to preload likely accessed nodes into its internal memory. This predictive mechanism ensures immediate data access during query execution, significantly improving system responsiveness.

The query procedure for the local knowledge graph 410 proceeds as follows:

In step S361, the hardware accelerator 200 accesses the local knowledge graph 410 G_{local} via the data loader 270. The data loader 270 partitions the knowledge graph into data blocks sized to fit the on-chip memory 273 of the hardware accelerator 200. Each data block contains a portion of the graph structure, such as nodes and edges. Assuming the knowledge graph is partitioned into k subregions, namely R₁, R₂, . . . , Rₖ. The data loader 270 decompose the task into multiple subtasks job, according to the mapping between the central term and the subregions of the knowledge graph (described in an example below), and distributes these subtasks to the task queue. Each subtask retains its corresponding central term c_{q}.

Specifically, for each query task qᵢ, where i∈[1,n] and n is the total number of query tasks, the data loader 270 decomposes the query task qᵢ into m subtasks jobᵢ, where i∈[1,m] and m is the total number of subtasks. Each subtask corresponds to a subregion for querying.

Specifically, the central term of each query is queried across all graph subregions, generating multiple subtasks for each central term executed in parallel across subregions. For example, if the central terms of a query qᵢ are “hummingbird” and “habitat”, and the knowledge graph is partitioned into three subregions R₁, R₂, R₃, the query task is decomposed into six subtasks job₁, job₂, job₃ . . . , job₆, each corresponding to a pair of a central terms and a subregion. For instance, job₁ represents a query for the central term “hummingbird” in subregion R₁, returning all neighbors of “hummingbird” in subregion R₁ along with their relationships, such as “habitat: tropical rainforest” and “food: nectar”.

The task decomposition and distribution strategy of the data loader 270 significantly enhances parallel query processing, leveraging the parallel computing capabilities of the hardware accelerator 200. By partitioning the knowledge graph into subregions and splitting queries into subtasks, the hardware accelerator 200 can process multiple tasks concurrently, reducing overall processing time.

The effectiveness of this optimization stems from the rational subregion partitioning and task decomposition. Partitioning the knowledge graph into subregions constrains the query scope, mitigates memory access conflicts, and improves data locality. Preserving central terms in subtasks ensures task independence and semantic completeness, enabling the hardware accelerator 200 to efficiently process complex queries and return results rapidly. This strategy significantly improves system throughput and responsiveness, particularly for large-scale graph data.

In step S362, the decomposed subtasks are directed to the task queue by the data loader 270 and queued for processing based on priority. The task queue ensures orderly task execution and efficient resource scheduling.

Specifically, the priority is determined based on:
Subregion workload: Tasks in lighter-loaded subregions are prioritized to avoid delays due to task accumulation.
Task arrival time (FIFO principle): Tasks arriving earlier are prioritized under similar loads to ensure sequential execution.

In the present disclosure, the priority formula is defined as:

$${P}_{job} = \frac{1}{Load} + δ \cdot {T}_{arrival} ,$$

where P_{job} is the task priority, Load is the current subregion's workload, Tₐᵣᵣᵢᵥₐₗ is the task arrival time, and δ is the temporal weighting parameter. This formula balances workload and arrival time, ensuring efficient resource allocation and minimizing latency. This mechanism enables dynamic workload balancing and optimizes task scheduling.
Step S363: Tasks in the task queue are dispatched to the computation module 290 based on priority via the task dispatch unit 312 within the on-chip controller 311.

For example, if the central terms of query qᵢ are “giant panda” and “China”, and the knowledge graph is partitioned into three subregions R₁, R₂, R₃. The query is then decomposed into six subtasks job₁, job₂, job₃ . . . , job₆, each corresponding to a specific pair of a central term and a subregion. For example, job₁ represents a query for the central term “giant panda” in subregion R₁. With all subtasks job₁ executed in parallel, the total parallel computation time is:

$${T}_{total} = max ( {T}_{{job}_{1}} , {T}_{{job}_{2}} , … , {T}_{{job}_{m}} ) ,$$

where T_{job}_{ₘ} is the execution time of the m^{th} subtask. The query task is completed through parallel processing.

This parallel execution significantly improves computation efficiency and reduces query latency. By processing multiple subtasks concurrently across computation units, the system maximizes hardware resources utilization, enhancing concurrency and completing large-scale queries rapidly. This architecture prevents bottlenecks by distributing load across computation units.

The advantage of parallel execution also lies in flexible scheduling. As computation units process graph query subtasks across subregions concurrently, the system can dynamically adjust task dispatch strategies based on real-time workload, optimizing resource utilization. This design ensures high responsiveness and efficiency under high-load scenarios, making it suitable for large-scale, high-frequency data queries.

In step S364, the computation module 290 transmits the computation results of each subtask to the differential privacy processing unit 300. The differential privacy processing unit 300 injects noise to protect sensitive information, ensuring user privacy protection during multi-source knowledge extraction.

The differential privacy processing unit 300 applies differential privacy noise injection and cosine similarity filtering to the candidate neighbors retrieved from graph queries. Cosine similarity filtering, based on a vector space model, measures the similarity between vectors to assess their relevance, effectively filtering out low-relevance items and improving result accuracy in text, image, and knowledge graph scenarios. The purpose of cosine similarity filtering is to prevent excessive neighbor information for the central term, ensuring that only highly relevant knowledge items are stored in the multi-tier cache.

The operation of the differential privacy processing unit 300 primarily comprises the step illustrated in FIG. 7.
Step S371: Receive graph query subtasks.

This is about receiving query qᵢ, central term c_{q}, local knowledge graph G_{local}, privacy budget E, and the number of entities n to be returned.
Step S372: Compute the connection strength vector of neighbors.

The connection strength vector X is computed based on neighbors in the local knowledge graph 410 G_{local} associated with the central term c_{q}. The vector X includes all entities in the current knowledge graph, with each dimension initialized to 0. For neighbor entities of the central term c_{q}, the corresponding dimensions in X are set to 1, while dimensions for unrelated entities remain 0.

Specifically, the connection strength vector measures the association between the central term in the query and its neighbors in the local knowledge graph 410. For each central term c_{q} (which may include multiple terms, as in the previous “giant panda” example), each dimension of X corresponds to an entity, initially set to 0. If a central term c_{q} has a direct connection with a neighbor entity et, the corresponding dimension in X is set to 1.

The connection strength vector is computed as:

$${X}_{i} = \{ \begin{matrix}1 , & if {e}_{i} is a neighbor of {c}_{q} \\ 0 , & otherwise\end{matrix} ,$$

where Xᵢ is the value of the connection strength vector X for entity eᵢ. This approach efficiently identifies query-related entities, optimizing graph query efficiency.
Step S373: Inject Laplace noise into the connection strength vector to derive candidate neighbors.

To protect neighbor information privacy, Laplace noise Lap (1/ϵ) is injected into the connection strength vector X, yielding the noise-injected connection strength vector X′, where

$${X}^{′} = X + Lap ( 1 / ϵ ) .$$

Step S374: Compute cosine similarity between candidate neighbors and the query.

The noise-injected connection strength vector X′ is sorted by dimensional values, and the top n entities are selected to form initial candidate neighbor set R_{nbr} for preliminary retrieval.

For each entity vᵢ in the candidate neighbor set R_{nbr}, the cosine similarity with query q, which serves as the correlation score, is computed as follows:

$$I ( q , {v}_{i} ) = \frac{q \cdot {v}_{i}}{‖ q ‖ ‖ {v}_{i} ‖} ,$$

where I(q,vᵢ) is the cosine similarity, and q and vᵢ are the embeddings of query q and entity vᵢ, respectively.
Step S375: Filter candidate neighbor entities to produce the final neighbor set, and select the highest-scoring entities based on cosine similarity as the final knowledge set R.

Cosine similarity filtering ensures that only the most relevant neighbor information for the central term is retained, preventing cache resource waste due to excessive neighbors. Without further filtering, the candidate neighbor set processed with differential privacy alone could be excessively large in large-scale knowledge graphs, leading to prolonged subtask and redundant data irrelevant to query responses. By computing cosine similarity scores between each neighbor entity and query q, the system effectively measures semantic similarity, retaining neighbors most closely aligned with the central term.

This filtering significantly improves multi-tier cache utilization efficiency. Storing only highly relevant knowledge items reduces cache miss rates, enhances overall query performance, and improves response speed. Prioritizing high-similarity neighbors ensures valuable data for subsequent queries, minimizing unnecessary data transfers and processing, thereby improving overall resource utilization and query accuracy.
Step S376: Determine whether any subtask remains. If subtasks remain, proceed to process the next subtask by receiving graph query subtasks; otherwise, proceed to Step S350.

In other words, the computation results are processed by the differential privacy processing unit 300, forming knowledge sets Reᵢ, where i∈[1,m] and m is the total number of subtasks. The knowledge sets Re; are then transferred to the result aggregation unit 330, concluding the process.

In Step S350, the differential privacy processing unit 300 sends the knowledge sets Re; to the result aggregation unit 330 to integrate the computation results of multiple subtasks.

During integration, the result aggregation unit 330 deduplicates the outputs of subtasks, ensuring each knowledge item appears only once. The deduplicated results are aggregated into a complete query result set R_{kw}. This deduplication enhances result accuracy by removing redundant information and preventing user confusion. Moreover, the simplified result set reduces storage and transmission overhead, improving overall system efficiency. It also accelerates subsequent processing and resource utilization, enabling faster query responses.

For example, if the central terms of the query are “hummingbird” and “habitat”, subtask results include “habitat: tropical rainforest” and “food: nectar” for “hummingbird”, and “environment: tropical rainforest” and “inhabiting species: hummingbird, American alligator” for “habitat”. The result aggregation unit 330 aggregates these results, removes duplicates, and forms a complete result set containing habitat and food information for “hummingbird” and environmental and inhabiting species information for “habitat”. The query result R_{kw} is then written back to the local cache of the hardware accelerator 200, enabling rapid cache hits for similar queries and reducing redundant computations.

In the knowledge aggregation phase S400, the caching module 120 merges and organizes retrieval results from multiple sources, ensuring data consistency and completeness.

The merging and organizing process is similar to the result aggregation performed by the aggregation unit 330 during the deep search. The caching module 120 merges results and deduplicates them, ensuring each result appears only once. The merged data is then stored in the server-side cache, providing faster access for subsequent queries and processing, reducing redundant retrieval overhead, and enhancing overall system performance.

In the augmented response phase S500, the server-side caching module 120 sends the merged and organized knowledge data to the data processor 110 to enhance the answering capability of the large language model.

Specifically, the data processor 110 textualizes the query result K_{L1} from the coarse search phase or the query result R_{kw} from the knowledge aggregation phase, and uses it as a prompt for the LLM. The LLM performs inference to generate a response enhanced with textual information.

This approach enables the LLM to incorporate information from multiple local knowledge graphs, enhancing the accuracy, depth, and relevance of the response. This knowledge-aggregated response strategy allows the system to provide broader and deeper answers for complex queries, meeting diverse user needs.

The present disclosure provides the following technical advantages:

Common knowledge retrieval systems typically rely on software-level optimization, limiting their ability to leverage hardware resources, resulting in slow processing speeds and inability to meet large-scale concurrent query demands. To address this, the hardware accelerators 200 of the present disclosure employ multiple optimization techniques, including parallel computation, cache access optimization, and prefetching, significantly improving knowledge retrieval efficiency. Parallel computation accelerates query task execution; cache locality optimization reduces data access latency; and prefetching proactively loads data blocks, minimizing wait times.

These techniques synergistically mitigate retrieval bottlenecks, enabling faster information extraction from the local knowledge graph within a shorter time and enhancing retrieval throughput to meet real-time requirements. Existing knowledge retrieval systems often expose sensitive information during multi-source data integration due to inadequate privacy protection, particularly in federated learning and distributed data environments. To address this, the present disclosure introduces a differential privacy mechanism that injects noise into sensitive data, ensuring user privacy and data security. During federated knowledge retrieval, this mechanism applies noise to connection strength vectors of neighbors, concealing access patterns and sensitive associations. Even in distributed cross-source data integration, the mechanism effectively prevents sensitive information leakage, enhancing system reliability for privacy-sensitive data.

It should be noted that the above-mentioned embodiments are exemplary. Those skilled in the art, inspired by the present disclosure, may devise various solutions within its scope and protection. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, with terms like “preferably” or “according to a preferred embodiment” indicating distinct concepts in respective paragraphs. The applicant reserves the right to file divisional applications for each inventive concept.

What is claimed is:

1. A system for federated knowledge retrieval and large language model enhancement, the system comprising a server and hardware accelerators,
wherein the server is configured to preprocess an input query to extract a central term and retrieve the central term through its caching module, wherein upon a cache hit, the caching module provides a query result corresponding to the central term to a data processor for a large language model (LLM) to perform inference and generate an augmented response;
upon a cache miss in the caching module, the server is configured to send a retrieval instruction to the hardware accelerators to perform retrieval in each hardware accelerator's local cache;
upon a further cache miss in the local cache, the hardware accelerators are configured to invoke a local knowledge graph, partition the local knowledge graph to generate parallel subtasks associated with the central term to perform a deep search, and inject noise into knowledge items retrieved by the parallel subtasks to protect sensitive information, and
the hardware accelerators are configured to integrate the noise-injected knowledge items and send them to the data processor through the caching module for the LLM to perform inference and generate an augmented response.

2. The system of claim 1, wherein each hardware accelerator comprises:
a data loader configured to acquire data from a local knowledge graph in batches and partition the knowledge graph into a plurality of data blocks sized to fit the hardware accelerator's on-chip memory;
a computation module configured to perform parallel computation;
a differential privacy processing unit configured to inject noise into sensitive data during processing to secure data privacy; and
a result aggregation unit configured to aggregate output information from a plurality of computation units in the computation module and perform analysis and processing to ensure completeness and consistency of a final result.

3. The system of claim 2, wherein the data loader further comprises a task decomposition unit configured to:
during data loading, search the central term of the query in all partitioned subregions of the knowledge graph.

4. The system of claim 3, wherein each hardware accelerator further comprises an on-chip controller comprising:
a task dispatch unit configured to receive and distribute subtasks from a task queue to ensure a balanced workload among computation units in the computation module;
an instruction decoder configured to translate high-level task instructions into hardware-specific operational instructions to direct the computation units to execute corresponding tasks; and
a state management unit configured to monitor each module in real time and coordinate resource allocation to ensure correct task execution and system stability.

5. The system of claim 4, wherein each hardware accelerator further comprises a prefetch unit configured to:
predict potential data requirements based on historical access patterns and prefetch data from nodes in the knowledge graph using a Markov chain model to preload the data and reduce latency in query processing.

6. The system of claim 5, wherein the prefetch unit of the hardware accelerator predicts nodes likely to be accessed during query processing based on a Markov chain model, comprising,
constructing the Markov chain model based on historical access patterns prior to query processing; and
predicting a node access path using the Markov chain model.

7. The system of claim 6, wherein the server comprises a data processor and a caching module,
wherein the data processor is configured to extract a central term, run a coarse search program, and send the extracted central term to the caching module;
the caching module is configured to search for a corresponding knowledge item;
upon existence of a knowledge item corresponding to the central term, the caching module directly returns a query result to enter an augmented response phase, wherein the query result comprises neighbors of the central term, and
the data processor is configured to convert the query result to text and input the text to a large language model (LLM) for inference to generate an augmented response.

8. The system of claim 7, wherein the data processor of the server is further configured to, upon finding no relevant knowledge items during a coarse search, send deep search requests to local-side computers through the Internet;
wherein each local-side computer is configured to receive the query request from the server through a network adapter and run a deep search program according to the query request, and
wherein the deep search program accesses an accelerator chip of the hardware accelerator through a high-speed bus.

9. The system of claim 8, wherein upon a cache miss in the caching module, the system is configured to trigger a deep search request and associated protocols, wherein the data processor is configured to encapsulate the query request into a standard data packet and distribute it to local nodes using a load balancing algorithm.

10. The system of claim 9, wherein the local-side computer is configured to activate a task queue management function of an on-chip controller in the hardware accelerator, and compile a deep search program into hardware microinstructions through an instruction decoder.

11. A method for federated knowledge retrieval and large language model enhancement, comprising:
preprocessing an input query by a server to extract a central term;
retrieving the central term through a caching module of the server, wherein upon a cache hit, the caching module provides a query result corresponding to the central term to a large language model (LLM) for inference to generate an augmented response;
upon a cache miss in the caching module, sending a retrieval instruction from the server to hardware accelerators to perform retrieval in each hardware accelerator's local cache;
upon a further cache miss in the local cache, invoking a local knowledge graph by the hardware accelerators, partitioning the local knowledge graph to generate parallel subtasks associated with the central term for performing a deep search, and injecting noise into knowledge items retrieved by the parallel subtasks to protect sensitive information; and
integrating the noise-injected knowledge items by the hardware accelerators and sending them through the caching module to a data processor for the LLM to perform inference and generate an augmented response.

12. The method of claim 11, wherein the local cache employs a hot-cold data dual storage mechanism to enhance retrieval efficiency, comprising:
storing cold data and hot data in different types of storage media;
monitoring access frequency or timestamps of data items,
initiating a migration process when the access frequency of a data item exceeds a predetermined threshold;
removing low-frequency data from a hot cache and storing it in a cold storage with lower access speed; and
migrating frequently accessed data from the cold storage to the hot cache to ensure fast access.

13. The method of claim 12, further comprising:
acquiring data from a local knowledge graph in batches and partitioning the knowledge graph into a plurality of data blocks sized to fit the hardware accelerator's on-chip memory;
performing parallel computation;
injecting noise into sensitive data during processing to secure data privacy; and
aggregating output information from a plurality of computation units and performing analysis and processing to ensure completeness and consistency of a final result.

14. The method of claim 13, further comprising:
during data loading, searching a central term of a query in all partitioned subregions of the knowledge graph.

15. The method of claim 14, further comprising:
receiving and distributing subtasks from a task queue to ensure a balanced workload among computation units in a computation module;
translating high-level task instructions into hardware-specific operational instructions to direct the computation units to execute corresponding tasks; and
monitoring each module in real time and coordinating resource allocation to ensure correct task execution and system stability.

16. The method of claim 15, further comprising:
predicting potential data requirements based on historical access patterns and prefetching data from nodes in a knowledge graph using a Markov chain model to preload the data and reduce latency in query processing.

17. The method of claim 16, further comprising:
predicting nodes likely to be accessed during query processing based on a Markov chain model,
wherein the Markov chain model is constructed based on historical access patterns prior to query processing and is used to predict a node access path.

18. The method of claim 17, further comprising:
extracting a central term and running a coarse search program;
searching for a corresponding knowledge item;
upon existence of a knowledge item corresponding to the central term, directly returning a query result to enter an augmented response phase, wherein the query result comprises neighbors of the central term; and
converting the query result to text and inputting the text to a large language model (LLM) for inference to generate an augmented response.

19. The method of claim 18, further comprising:
upon finding no relevant knowledge items during a coarse search, sending deep search requests to local-side computers through the Internet;
receiving, by each local-side computer, a query request from a server through a network adapter;
running, by the local-side computer, a deep search program according to the query request; and
accessing, by the deep search program, each hardware accelerator's accelerator chip through a high-speed bus.

20. The method of claim 19, further comprising:
upon a cache miss in a caching module, triggering a deep search request and associated protocols, encapsulating a query request into a standard data packet by a data processor, and distributing the data packet to local nodes using a load balancing algorithm.
